(19) United States
(12) Patent Application Publication
(10) Pub. No.: US 2009/0184002 A1
(43) Pub. Date: Jul. 23, 2009

(54) BIOSENSOR DEVICE

(75) Inventors: Yukiko Furukawa, Veldhoven (NL); Joukje Garrelina Orsel, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,126

(22) PCT Filed: Apr. 24, 2007
(86) PCT No.: PCT/IB2007/051510

§ 371 Date: Oct. 31, 2008

(30) Foreign Application Priority Data
May 3, 2006 (EP) 06113420.1

(51) Int. Cl. G01N 27/26; B23P 17/00

(52) U.S. Cl. 205/775; 204/406; 29/592.1

(57) ABSTRACT

A biosensor device (10) for detecting of molecules of an analyte in a sample (23) comprising: an identification element (18) comprising at least one self assembling monolayer (26) having a first surface, a transducer element (20) comprising a metal electrode (34) for receiving an electric signal from the reaction of the molecules in the sample with the at least one self assembling monolayer (26), and at least one electronic element (14, 16) for receiving the electric signal from the transducer element (20), for processing, and/or storing the electric signal. The at least one self-assembling monolayer (26) comprises at least one carboxylic acid-group for coupling the at least one self-assembling monolayer (26) to the surface (32) of the metal electrode (34).

The invention relates to a biosensor device for detecting molecules in a sample, comprising an identification element comprising at least one self assembling monolayer, a transducer element comprising a metal electrode for receiving an electric signal from the reaction of the molecules in the sample with the at least one self assembling monolayer, wherein the metal electrode has a surface, and at least one electronic element for receiving the electric signal from the transducer element and for processing and/or storing the electric signal.

The invention further relates to a method for producing a biosensor device, comprising the steps of providing an identification element with at least one self assembling monolayer for identifying molecules in a sample, providing a transducer element having a metal electrode for receiving an electric signal from a reaction of the molecules in the sample with the at least one self assembling monolayer, and providing at least one electronic element for receiving, processing and/or storing the electric signal.

The invention still further relates to a method for detecting molecules in a sample.

A biosensor device of the kind mentioned at the outset is generally known.

Biosensor devices are generally known in the field of molecular diagnostics such as for protein detection and pathogen identification. Biosensor devices combine a high analytical performance with ease of use and low cost and are generally based on the integration of an identification element, a transducer element and an electronic element on an integrated circuit (IC), made of a semiconductor like silicon or gallium arsenide or the like. The identification element of the biosensor device is, in particular, an immobilized biological, biochemical or biomedical active system, wherein the molecules of the active system interact with the molecules in the sample.

In the transducer element, the interaction is sensed and a signal is generated according to the interaction between the molecules of the sample and the molecules of the identification element. The generated signal can be an optical, electrical and/or a magnetic signal, which is transformed into an electric signal. In some well-known embodiments, the transducer element comprises an electrode for receiving and/or generating the electric signal. The electronic element provides the processing and storing of the electric signal obtained from the transducer element.

In general, changes, for instance changes in the thickness of the identification element, the refractive index of the identification element, the light absorption, the magnetic properties and/or the electric properties introduced in the identification element by the interaction with the molecules in the sample are sensed by the transducer element. Transducer elements comprise therefore optoelectrical sensors, amperometric sensors, potentiometric sensors, magnetic sensors and/or electric sensors. Accordingly, chemical biosensors, optical biosensors, magnetic biosensors and electric biosensors depending on the sensed physical property are known.

In general, biosensor devices are able to detect specific biological molecules at very low concentrations (≧10⁻¹⁵ moles/litre).

A biosensor device is often sensitive and selective, wherein the identification element comprises a self-assembling monolayer performing a sensitive part of the biosensor device. Therefore, the self-assembling monolayer of the identification element has to be coupled to the transducer element.

A multi-array device using a self-assembling monolayer is known from the US 2005/0250097 A1. Therein, a self-assembling monolayer comprising a sulphur-containing compound, in particular a thiolated compound, which is adsorbed on a base plate, is disclosed. The sulfhydryl of the thiolate reacts with a surface of the base plate and the self-assembling monolayer self assembles by coupling to the base plate.

In order to couple the thiol—containing component to the surface of the base plate, it is preferred to clean the surface, because any organic contaminations and oxides can prevent the self-assembling monolayer from being adsorbed and coupled onto the electrode. Several cleaning techniques, such as plasma treatments and wet cleaning, are known in order to perform the cleaning of the surface.

In the biosensor device, the identification element comprises the self-assembling monolayer and the transducer element generally comprises an electrode. The electrode is made from a conductive material for receiving the electric signal generated due to the interaction of the molecules in the sample with the identification element.

In general noble metals like gold, silver, and/or platinum are used. The cleaning works satisfactorily for electrodes made from gold, silver or platinum. If electrodes made from materials, which are less noble, like copper, are intended to be used, the known cleaning techniques are not suitable anymore. This is, because oxide layers on the surface of the metal electrode are formed even directly after the cleaning has been performed. Therefore, an electrode made of a base metal always has an oxidized surface on top of the metal electrode.

Therefore, it is an object of the present invention to provide a biosensor device integrated on a semiconductor IC, wherein the identification element can be directly coupled to the metal electrode of the transducer element without applying a cleaning procedure to the electrode.

Further, it is an object of the present invention to provide a method for producing a biosensor device.

Further, it is an object of the present invention to provide a method for detecting molecules in a sample.

According to the invention, the object is solved with respect to the biosensor device as mentioned at the outset, in that the at least one self-assembling monolayer (SAM) comprises a carboxyl-group for coupling the at least one self-assembling monolayer to the surface of the metal electrode.

The carboxyl-group has the effect to reduce a metal oxide on the surface of the metal electrode and thereby provides a removal of the metal oxide from the surface of the electrode. Preferably a clean metal surface without substantial presence of, more preferred without any metal oxide on the surface is provided. A metal-COO-bond can be formed, because the carboxylic acid-group (COOH-group) easily dissociates to COO— and the proton (H⁺).

The advantage of the biosensor according to the invention is that an additional cleaning process with the purpose to remove the metal oxide layer from the surface of the metal electrode is not necessary.

It is advantageous to use the carboxyl-group, because the metal-carboxyl-bonds, which are formed as an interface layer between the self-assembling monolayer and the surface of the electrode, are stable. In particular the metal carboxyl—bonds are more stable than metal-thiolyte-bonds comprising thiolyte compounds, as known from the prior art. This especially applies for Cu-carboxyl bonds. A stable bond between the self-assembling monolayer and the metal electrode leads to a longer lifetime of the biosensor device. Further an improved oxidation resistance and a lower noise resulting in an improved electrical property of the biosensor is obtained.

According to an embodiment of the biosensor device, the electrode of the transducer element is patterned, wherein the self-assembling monolayer (SAM) is coupled to the surface of the patterned electrode.

A patterned electrode is advantageous, because a higher spatial resolution of the signal obtained/received by the patterned electrode of the transducer element can be obtained.

According to a further preferred embodiment, the carboxyl-group is a first carboxyl-group and the self-assembling monolayer further comprises a second carboxyl-group, wherein the second carboxyl-group is intended to be directed to the sample to be investigated.

The second carboxyl-group intended to be directed to the sample comprising the analyte to be investigated advantageously reacts with a capture molecule, (e.g. an antibody or fragment thereof, DNA, aptamers). The analyte is preferably selected from the group comprising protein, DNA. RNA, hormones and metabolites. The capture molecule, preferably selected from the group comprising antibody, DNA, binds a target analyte in the sample, preferably a protein, called targeted protein, specifically. The targeted protein can be a cardiac marker, an inflammation marker such as CRP or a cytokine or any other protein of diagnostic interest.

According to a further preferred embodiment, the metal electrode is made of copper or an alloy comprising copper.

Copper is the metal that is most commonly used as an interconnecting part of an advanced semiconductor integrated circuit, the biosensor device is integrated on. Copper (Cu) is very easily oxidized forming a copper-oxide (CuₓO_{y}) layer onto the surface of the electrode even at room temperature, wherein oxygen (O₂) and copper (Cu) react and form the copper oxide (CuₓO_{y}) compound.

In reality, it is difficult to obtain a clean copper surface of the electrode if the copper surface is exposed to air or an environment containing oxygen. The copper oxide layer will be formed immediately. The handling under protective gas atmosphere could prevent the formation of the copper oxide layer. Therefore, it is advantageous to use the carboxyl-group of the self-assembling monolayer in order to perform the reduction of the copper oxide layer and thereby remove the metal oxide from the surface of the metal electrode.

According to a further preferred embodiment, the metal electrode is a first electrode and the transducer element further comprises a second electrode, wherein the electric signal is produced by a change in the capacity between the first electrode and the second electrode.

In this configuration, the transducer element comprises two electrodes, which form a capacitor with the self-assembling monolayer in-between. In case the antibody and the protein are reacting with the self-assembling monolayer, the capacity of the capacitor is changed. This results in a changed electric signal. Hence, by measuring the electric signal, the change in the capacity can be sensed and the adsorption of an analyte such as a protein to a capture molecule such as an antibody can be detected. Thereby, the biosensor device is selective to target proteins when a specific antibody that is selective for the protein adsorbed is adsorbed or bonded to the self-assembling monolayer. The biosensor device thereby is sensitive to a specific protein via an antibody-protein ‘reaction’.

In another embodiment, both electrodes are covered with self-assembling monolayer and capture molecule. A change of impedance between the electrodes upon binding of analyte molecules from the sample to the electrodes is measured.

In an alternative aspect of the invention, the analysis method is carried out as a displacement assay. In this embodiment, it is preferred that analytes bind on the base-plate-SAM-capture molecule layer. These analytes carry a label that is easily detected. The capture molecules loaded with labelled analyte are then exposed to the sample and analytes from the sample may replace labeled analyse in their position and thus may link to the capture molecule. This results in a decrease in signal due to a decrease in labeled analytes being bound to the capture molecules. This decrease is inversely related to the concentration of analyte in the sample that is analyzed.

According to another aspect of the invention, the object with respect to the method for producing a biosensor as mentioned at the outset is solved, in that the self assembling monolayer is directly coupled to the surface of the metal electrode by means of a carboxyl-group of the self assembling monolayer.

Again, an external cleaning process of the metal electrode can be skipped in an advantageous manner. The production of the biosensor device using a metal electrode, in particular a copper electrode has been enabled. The use of the carboxyl-groups is advantageous, because bonds, namely COO-M-bonds, are created between the metal (M) of the metal electrode and the carboxyl-group and thereby removing the metal oxide from the surface or incorporating the metal oxide in the COO-M bond. Due to the COO-M-bonds, a higher stability and thereby a long lifetime of the biosensor device is achieved.

Advantageously, the metal electrode can be made of a metal, like copper, forming very easily a metal oxide layer, because the carboxyl-group removes or incorporates the copper oxide layer on the surface of the copper electrode and the bonds between the carboxyl-group and the copper are formed.

According to another aspect of the invention, the object with respect to the method for detecting molecules in a sample is solved, in that a biosensor device according to the present invention is provided, a capture molecule, preferably an antibody, is bound to a self assembling monolayer of the biosensor device, an analyte, preferably protein in the sample is attached by the capture molecule, and an electric signal is generated due to an interaction between the capture molecule and the analyte.

Typically, a measurement of an analyte in a sample with the biosensor device is performed using three steps: Firstly, the molecules in the sample are selectively identified by the identification element of the biosensor device. Herein, the identification is performed by coupling the molecules in the sample to be investigated to the identification element. Secondly, an interaction of the analyte molecules in the sample with the molecules of the identification element causes a change in an electric, magnetic, and/or optic property of the identification surface layer. The change of the property is sensed by the tranducer element. The transducer element transduces the sensed changes into an electrical signal. Thirdly, the electric signal is then received, amplified, processed and/or stored in a computer or a memory chip. Finally if desired, the system is reset, such that a new measurement can be performed.

The self-assembling monolayer comprises at least two carboxylic acid-groups, wherein at least one carboxyl-group can be coupled to the oxidized metal surface of the electrode and the at least one carboxyl-group can be coupled to the capture molecule, preferably an antibody. The electric signal is generated when the capture molecule, preferably antibody interacts with the analyte, preferably protein.

Thereby, the biosensor device is sensitive and selective of an interaction of the capture molecule, preferably antibody and the analyte in the sample, preferably protein. Specific proteins can be detected and identified in the sample, i.e. a biological solution to be investigated, if the corresponding antibody is coupled to the self-assembling monolayer. The biosensor device is thereby selective to specific proteins, which can be, for instance, cardiac marker, an inflammation marker, such as CRP or cytokines or any other proteins of diagnostic interest.

Important is that the at least second carboxyl-group forms a stable bond with the capture molecule, preferably antibody for example by forming a CONH-bond (peptide bond). The capture molecule, preferably antibody is selected depending on the targeted analyte, e.g. protein.

Depending on a shape and a length of the self-assembling monolayer, the electric property, which is expressed by the electric signal of the transducer element, can be influenced.

In summary, the at least first carboxyl-group of the self assembling monolayer can be used to bind to the metal oxide of the metal electrode and thereby forming a carboxyl-metal bond with the surface of the metal electrode and the at least second carboxyl-group is used to couple the antibody to the self assembling monolayer by preferably forming a CONH-bond.

The foregoing and further and more specific features and advantages of the present invention will become readily apparent for those skilled in the art following a detailed description of preferred embodiments thereof, taken in conjunction with the drawings in which:

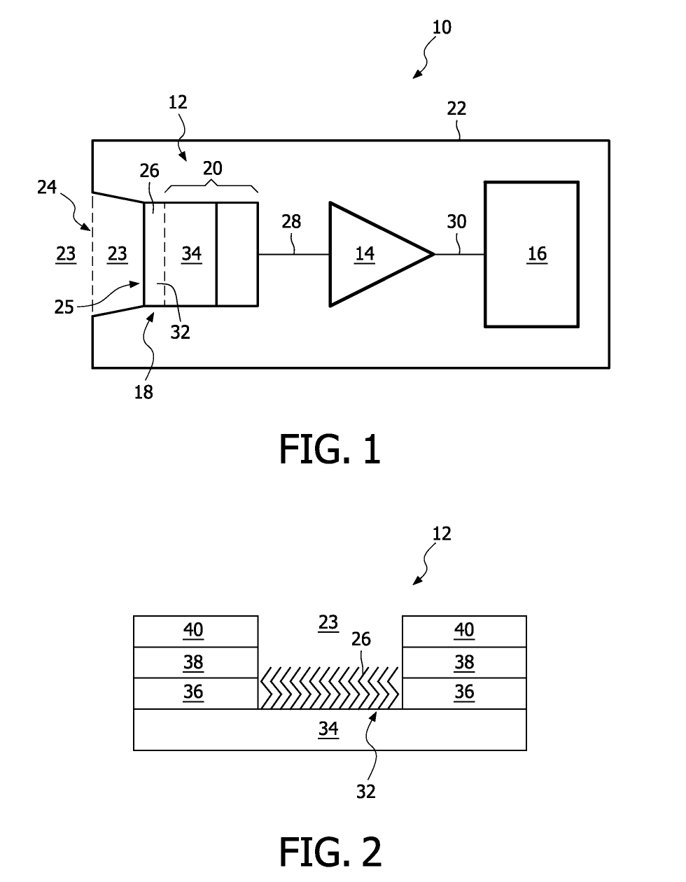

FIG. 1 shows a schematic view of a biosensor device;

FIG. 2 shows an electrode of the transducer element with an adsorbed self assembling monolayer (SAM); and

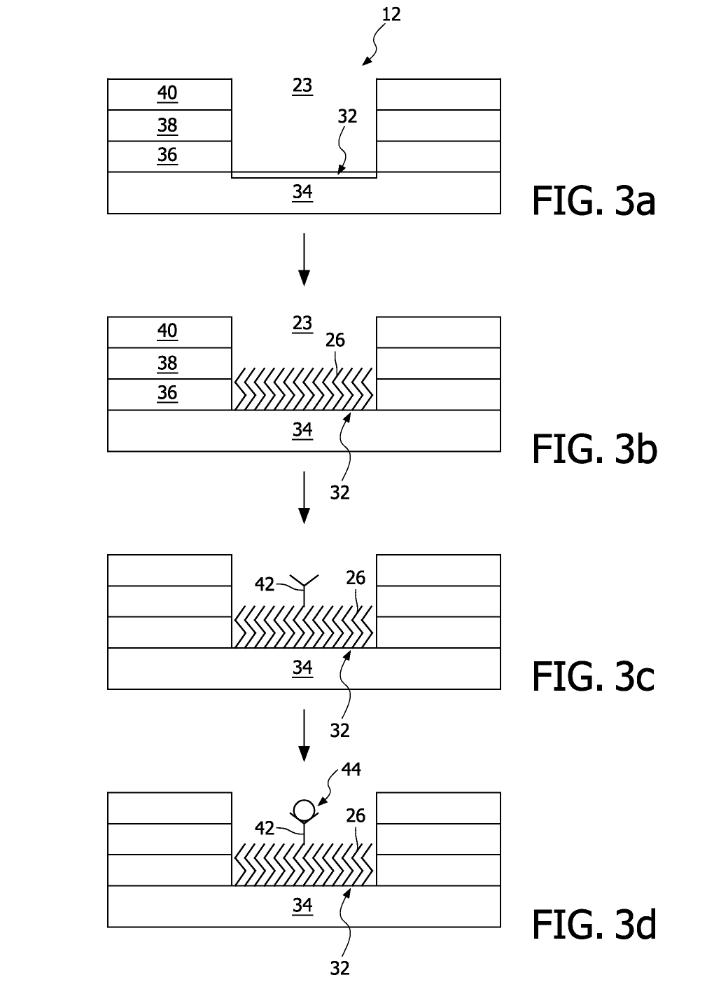

FIG. 3 shows the steps of selecting a protein from an sample using the biosensor device.

These drawings are illustrative for the invention and not to be interpreted as limiting.

FIG. 1 shows a schematic view of a biosensor device 10. The biosensor device 10 comprises a sensor element 12, an amplifying element 14 and an electronic element 16. The sensor element 12 comprises an identification element 18 and a transducer element 20, wherein the identification element 18 is shown in contact with an sample 23, which is a biological solution comprising molecules to be investigated like proteins, such as cardiac markers, inflammation markers, such as CRP and cytokines.

The biosensor device 10 is typically integrated on an integrated circuit (IC), schematically drawn as a rectangular casing 22, wherein the casing 22 comprises an opening 24 in order to allow the sample 23 to be investigated to come into contact with a surface 25 of the identification element 18. An electric signal, generated in the transducer element 20 is transported via a first connection 28 to the amplifying element 14, amplifying the electric signal. The amplifying element 14 is connected via a second connection 30 to the electronic element 16 performing the processing and/or storing of the electric signal from the transducer element 20.

According to the invention, the biosensor device 10 is integrated on a semiconductor integrated circuit (IC), wherein the semiconductor integrated circuit comprises the sensor element 12, the amplifying element 14 and the electronic element 16.

With the biosensor device 10 according to the invention, the sample 23 which is a biological solution that may comprise analytes such as proteins can be investigated, wherein the investigation comprises in particular the identification of specific proteins in the sample 23. The biosensor device 10 is sensitive to specific analytes e.g. proteins and can detect the analytes selectively. Herein, examples of proteins are in particular cardiac markers, inflammation markers, such as CRP and cytokines. According to the invention other proteins not mentioned here specifically, which are of diagnostic interest can be selectively identified by the biosensor device 10.

Specific for the use of the biosensor device 10 according to the invention is that an analysis of the sample 23, i.e. the identification of the analyte molecules such as proteins, can be performed repetitively, wherein the measurement can be performed in successive steps with short time intervals in between. The obtained electric signals are processed and stored in a computer. The biosensor device 10 is reset between successive measurements.

The working principle of the biosensor device 10 is described shortly in the following: In a sample 23 the biological molecule, in particular the protein interacts specifically with the identification element 18, wherein the identification element 18 comprises a self assembling monolayer (SAM) 32 which is intended to be directed to the sample 23 and thereby in contact with the sample 23 to be investigated. Due to an interaction of the capture molecule, e.g. protein with an antibody coupled to the self-assembling monolayer 32, the protein is attached to the self-assembling monolayer 32 and an electrical signal is generated and received by an electrode 34 of the transducer element 20. The electric signal is amplified by the amplifying element 14 and processed and/or stored in the electronic element 16.

The transducer element 20 comprises at least one electrode 34. In a preferred embodiment, the transducer element 20 comprises two electrodes, a first electrode and a second electrode, in order to measure a change in the capacity between the two electrodes. Herein, the two electrodes form a capacitor with the self-assembling monolayer in between.

The biosensor device 10 may also be referred to as biosensor chip, due to the fact that the biosensor device is integrated on a semiconductor integrated circuit (IC). The biosensor chip may comprise one biosensor device 10 or a plurality of biosensor devices 10.

In FIG. 2 a schematic view of a sensor element 12 is shown. The sensor element 12 comprises at least one electrode 34 made of a metal or a metal alloy and a self-assembling monolayer (SAM) 26, wherein the self-assembling monolayer 26 is coupled to the surface 32 of the metal electrode 34.

The sensor element 12 further comprises three layers 36, 38 and 40, wherein the layers 36 and 40 are dielectric layers made of, for example, titanium nitride (TiN), and the layer 38 particularly is a layer of a conductive material. The dielectric layers 36 and 40 have insulation properties. The layers 36, 38 and 40 are parts of an interconnection part of the semiconductor IC, the biosensor device 10 is integrated on and can be used in order to build a patterned biosensor device 10.

According to the invention, the electrode 34 is made of copper or an alloy comprising copper, because copper is a common material used for an electrode 34 in the interconnection part of an advanced semiconductor IC. Copper is a material, which is easily oxidized in air even at room temperature and forms a thin metal oxide layer comprising copper oxide onto the surface 32 of the metal electrode 34, in particular the copper electrode.

The self-assembling monolayer 26 comprises a carboxylic acid-group (COOH), which is coupled to the surface 32 of the electrode 34 by reacting with the oxidized copper surface. Thereby, a bond between the copper and the carboxyl-group is formed.

If the self-assembling monolayer 26 is coupled to the oxidized copper surface, the copper oxide is removed from the surface 32 or incorporated in the COO-M bond on the surface 32 of the electrode 34.

Hence, the electrode 34 is essentially free from copper oxides at the surface 32 when the self-assembling monolayer has been coupled to the surface 32 and is not further oxidised upon exposure to oxygen or oxygen containing compounds. This is advantageous, because an oxide-free metal surface of the electrode 34 minimizes the noise of the electric signal generated and improves the electric properties of the biosensor device 10. In particular the sensitivity of the biosensor device 10 is improved.

The metal electrode 34 can be made as a flat electrode or can be patterned forming a patterned electrode 34, the self-assembling monolayer 26 is coupled to.

In FIG. 3 the sensor element 12 is shown. In particular, in FIG. 3a the sensor element 12 is shown without the self assembling monolayer 26, in FIG. 3b the sensor element 12 is shown with the self assembling monolayer 26 coupled onto the surface 32 of the electrode 34 and in FIG. 3c an antibody 42 has reacted with the self assembling monolayer 26 of the sensor element 12 and a bond has been formed between the self assembling monolayer 26 and the antibody 42. In FIG. 3d a protein 44 has been adsorbed to the antibody 42 and the targeted protein 44 is attached to the antibody 42.

The layers 36 and 40 can be used to form the patterning in particular to form a partition of the electrode 34. A measurement with a spatial resolution across the surface of the electrode 34 can be realized using patterned electrodes.

According to the invention, the self-assembling monolayer 26 comprises at least two carboxyl-groups, an at least first carboxyl-group and an at least second carboxyl-group, wherein the at least first carboxyl-group is intended to be directed to the sample comprising the analyte 23 and the at least second carboxyl-group, is coupled to the oxidized surface of the metal electrode 34. Thereby, the copper oxide forms a bond with the carboxyl-group directed to the surface 32 of the electrode 34.

The at least second carboxyl-group forms a COO-metal-bond and the a least first carboxyl-group of the self assembling monolayer 26 forms a bond with the capture molecule, particularly antibody, 42. The capture molecule 42 is chosen according and depending on the analyte (especially protein) 44 to be targeted, because there are specific capture molecule-analyte reactions. Herein, the targeted protein can be a cardiac marker, an inflammation markers, such as CRP and cytokines. The protein 44 can also be any protein of diagnostic interest. It can be seen, if in an embodiment, the antibody 42 and the protein 44 fit to one another, the antibody interacts with the targeted protein 44.

If the antibody 42 interacts with the protein 44, an electric signal is generated and directed to the electronic element 16 of the biosensor device 10. The electric signal can be produced, for instance, by a change in the resistance of the electrode 34.

Preferably, the electric signal is a change in the capacity between a first and a second electrode, wherein the biosensor device 10 comprises two electrodes 34 in this embodiment.

Because metal-carboxylate-bonds, in particular copper-carboxylate bonds, are stable, the coupling between the self assembling monolayer 26 and the surface 32 of the copper electrode is very stable, which leads to a long lifetime and results in an improved oxidation resistance of the sensor element 12, in particular of the transducer element 20.

1. A biosensor device (10) for detecting molecules in a sample (23), comprising:
an identification element (18) comprising at least one self-assembling monolayer (26),
a transducer element (20) comprising a metal electrode (34) for receiving an electric signal from the reaction of the molecules in the sample (23) with the at least one self assembling monolayer (26), wherein the metal electrode (34) has a surface (32),
at least one electronic element (14, 16) for receiving the electric signal from the transducer element (20) and for processing and/or storing the electric signal,
characterized in that
the at least one self-assembling monolayer (26) comprises at least one carboxylic acid-group for coupling the at least one self-assembling monolayer (26) to the surface (32) of the metal electrode (34).

2. The biosensor device of claim 1, characterized in that the electrode (34) of the transducer element (20) is patterned, wherein the self-assembling monolayer (26) is coupled to the surface (32) of the patterned electrode (34).

3. The biosensor device of claim 1, characterized in that the carboxyl-group is a first carboxyl-group, and the self assembling monolayer (26) further comprises at least a second carboxyl-group, wherein the at least second carboxyl-group is intended to be directed to the sample (23) to be investigated.

4. The biosensor device of claim 1, characterized in that the metal electrode (34) is made of copper or of an alloy comprising copper.

5. The biosensor of anyone of claim 1, characterized in that the metal electrode (34) is a first electrode and the transducer element (20) comprises further a second electrode, wherein the electric signal is produced by a change in the capacity between the first and the second electrode.

6. A method for producing a biosensor device, comprising the steps of:
providing an identification element (18) with at least one self assembling monolayer (26) for identifying molecules in a sample (23),
providing a transducer element (20) having a metal electrode (34) for receiving an electric signal from the adsorption of the molecules in the sample (23) with the identification element connected to at least one self assembling monolayer (26), and
providing at least one electronic element (14, 16) for receiving, processing and/or storing the electric signal,
characterized by the further step of:
coupling the self-assembling monolayer (26) to the surface (32) of the metal electrode (34) by means of a carboxylic acid-group of the self-assembling monolayer (26).

7. A method for detecting molecules in a sample (23), comprising the steps of:
providing a biosensor device (10) of claim 1,
binding a capture molecule (42) to the self assembling monolayer (26) of the biosensor device (10),
binding an analyte (44) in the sample (23) using the capture molecule (42), and
generating an electric signal due to an interaction between the capture molecule (42) and the analyte (44).

8. The method of claim 7, characterized in that the carboxylic acid-group of the self assembling monolayer (26) is a first carboxyl-group and the self assembling monolayer (26) comprises further at least a second carboxylic acid-group, wherein the coupling of the self assembling monolayer (26) to the metal electrode (34) is performed using the at least first carboxylic acid-group and the binding of the capture molecule (42) to the self assembling monolayer (26) is performed using the at least second carboxylic acid-group.

9. The method according to claim 7 wherein the capture molecule is an antibody.

10. The method according to claim 7 wherein the analyte molecule is a protein.
